(19) United States
(12) Patent Application Publication
(10) Pub. No.: US 2022/0362632 A1
(43) Pub. Date: Nov. 17, 2022

(54) MOTION RECOGNITION, AND EXERCISE AND GAME MIXED RHYTHMIC INTERIOR BIKE SYSTEM

(71) Applicant: UNIVR CO., LTD., Daejeon (KR)

(72) Inventor: Tae Jin KWAK, Daejeon (KR)

(21) Appl. No.: 17/318,614

(22) Filed: May 12, 2021

(51) Int. Cl. A63B 24/00; A63B 71/06; A63B 22/06; A63F 13/213; A63F 13/816

(52) U.S. Cl. CPC A63B 24/0062; A63B 71/0622; A63B 22/0605; A63B 24/0084; A63F 13/213; A63F 13/816; A63B 2220/833; A63B 2230/06; A63B 2220/803; A63B 2225/20; A63B 2024/0068; A63B 2220/805; A63B 2071/0655; A63B 2024/0096

(57) ABSTRACT

An interior bike system includes: an interior bike including a rotational angle detection sensor sensing a pedal rotation angular speed; a motion recognition sensor recognizing a head or upper body motion of a player; a heart rate measurement sensor measuring a heart rate of the player; a controller receiving and transferring sensing signals of the rotational angle detection sensor, the motion recognition sensor, and the heart rate measurement sensor to a web server; the web server determining whether performing the task motion given to the player is successful based on the signal of the motion recognition sensor of the controller, and generating a content image to which whether the player succeeds in performing the task motion is reflected and transmitting the generated content image to the content controller; and a display unit displaying an image transmitted from the web server through the controller.

### BACKGROUND

The present invention relates to a motion recognition, and exercise and game mixed rhythmic interior bike system.

Korean Patent Publication No. 10-1520816 discloses a health bicycle for a virtual reality game, which includes: a pedal which is rotated, a bicycle body having a handle rotatable in a horizontal direction, a speed calculation unit measuring a rotational speed of the pedal and calculating the measured rotational speed as a progress speed of the bicycle body, a direction calculation unit detecting a rotational angle of the handle and calculating a progress direction of the bicycle body, and a game unit body in which game contents in which a virtual reality is played, and reflecting and synchronizing the calculated progress speed and progress direction to the game contents, in which the direction calculation unit includes a rotational angle detection sensor installed on a central axis of the handle installed in the bicycle body and detecting the rotational angle of the handle, and a rotational angle calculator calculating the rotational angle detected by the rotational angle detection sensor as a progress direction of a wheel installed in the bicycle body and rolled, and an installation direction of the wheel is preset in the rotational angle calculator.

### SUMMARY OF THE INVENTION

The present invention has been made in an effort to provide a technology as a field that combines an interior exercise (e.g., cycling) and a game, in which a control unit recognizes an operation of a body (e.g., head) of a user who moves by an exercise to determine whether to perform an exercise task (reaching and moving to a corresponding point according to rhythm) presented by an instructor avatar and reflects the determination onto a display or a game.

Further, the present invention has been made in an effort to provide a technology that can perform a spinning (group rhythmic movement) motion presented by the display as interior cycling, and tracks a location of the head through an infrared sensor on the display and recognize whether the user achieves an operation required by an instructor (an avatar on the display) according to the rhythm and reflect whether user achieves the operation to contents.

Further, the present invention has been made in an effort to provide a system that performs a spinning interior bicycle exercise like a game by introducing a concept of attacking other players online or on another space or defending the user from other players when determining that a given task motion is achieved by the motion of the head.

A motion recognition, and exercise and game mixed rhythmic interior bike system according to the present invention is configured to include: an interior bike 100 including a rotational angle detection sensor 110 sensing a pedal rotation angular speed; a motion recognition sensor 200 recognizing a head or upper body motion of a player; a heart rate measurement sensor 250 measuring a heart rate of the player; a controller 300 receiving and transferring sensing signals of the rotational angle detection sensor 110, the motion recognition sensor 200, and the heart rate measurement sensor 250 to a web server 400; the web server 400 determining whether performing the task motion given to the player is successful based on the signal of the motion recognition sensor of the controller 300, and generating a content image to which whether the player succeeds in performing the task motion is reflected and transmitting the generated content image to the content controller 300; and a display unit 500 displaying an image transmitted from the web server 400 through the controller 300.

In the motion recognition, and exercise and game mixed rhythmic interior bike system according to the present invention, in the interior bike system, the web server 400 is preferably configured to include a sensor signal reception unit 410 receiving the sensing signals of the rotational angle detection sensor 110, the motion recognition sensor 200, and the heart rate measurement sensor 250, a task content selection unit 420 providing a selection menu to select an exercise task to be performed by the player, a difficulty level of the task, or a slow or fast degree of a rhythm motion, and provides the content image selected by the player, a task motion success determination unit 430 analyzes a motion signal received from the motion recognition sensor 200 to determine whether a head or upper body motion pattern of the player corresponds to a task motion range given by the contents (instructor avatar) (the motion task is successful), a pedal rotation task success determination unit 440 analyzes an angular speed signal of the pedal received from the rotational angle detection sensor 110 to determine whether a pedal rotation pattern of the player corresponds to a task pedal rotation range given by the contents (instructor avatar) (the pedal rotation task is successful), a content image reflection unit 450 provides a content image to which whether the player succeeds in the task motion or whether the player succeeds in the pedal rotation task, and an exercise data management unit 460 stores and manages player exercise data including the type of task selected by the player, a player heart rate of the player by the heart rate measurement sensor 250, whether the player succeeds in the task motion or whether the player succeeds in the pedal rotation task.

According to the present invention, provided is a motion recognition, and exercise and game mixed rhythmic interior bike system technology as a field that combines an interior exercise (e.g., cycling) and a game, in which a control unit recognizes an operation of a body (e.g., head) of a user who moves by an exercise to determine whether to perform an exercise task (reaching and moving to a corresponding point according to rhythm) presented by an instructor avatar and reflects the determination onto a display or a game.

Further, according to the present invention, provided is a motion recognition, and exercise and game mixed rhythmic interior bike system technology that can perform a spinning (group rhythmic movement) motion presented by the display as interior cycling, and tracks a location of the head through an infrared sensor on the display and recognize whether the user achieves an operation required by an instructor (an avatar on the display) according to the rhythm and reflect whether user achieves the operation to contents.

In addition, according to the present invention, provided is a system that performs a spinning interior bicycle exercise like a game by introducing a concept of attacking other players online or on another space or defending the user from other players when determining that a given task motion is achieved by the motion of the head.

### BRIEF DESCRIPTION OF THE DRAWINGS

FIG. 1 is an overall configuration diagram of a motion recognition, and exercise and game mixed rhythmic interior bike system according to an embodiment of the present invention.

FIG. 2 is a detailed configuration diagram of a web server in the motion recognition, and exercise and game mixed rhythmic interior bike system according to an embodiment of the present invention.

FIG. 3 is a configuration diagram of hardware of the motion recognition, and exercise and game mixed rhythmic interior bike system according to an embodiment of the present invention.

FIG. 4 is a diagram illustrating a content output screen of the motion recognition, and exercise and game mixed rhythmic interior bike system according to an embodiment of the present invention.

FIG. 5 is an explanatory diagram of a group game of the motion recognition, and exercise and game mixed rhythmic interior bike system according to an embodiment of the present invention.

### DETAILED DESCRIPTION OF THE PREFERRED EMBODIMENT

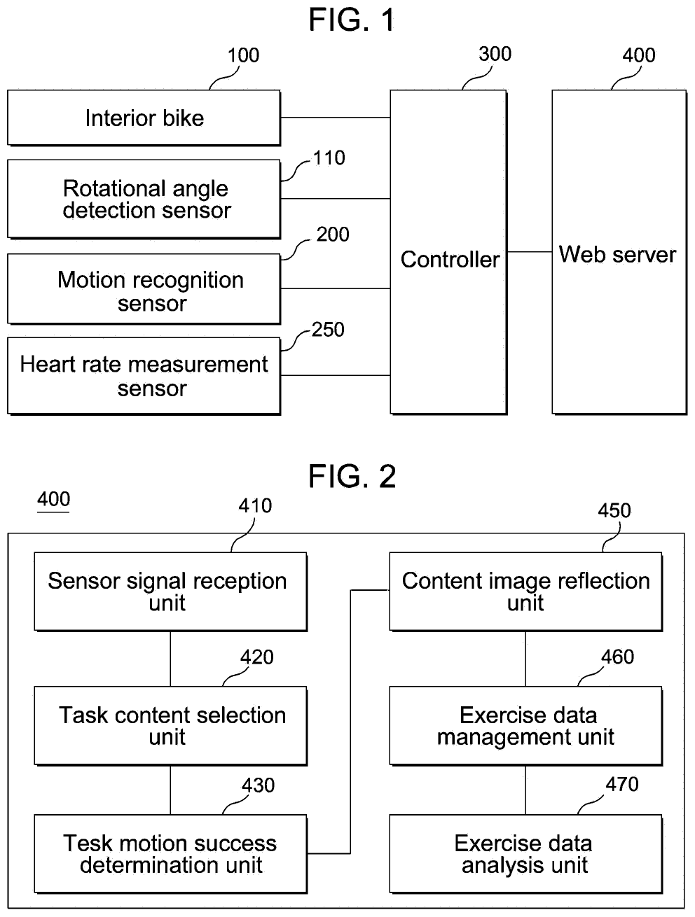

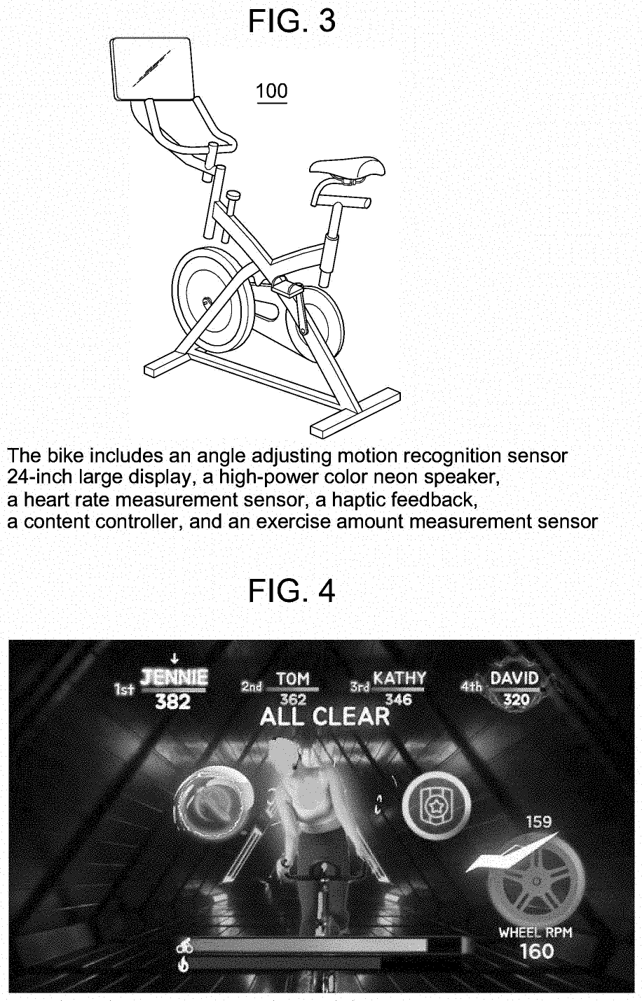

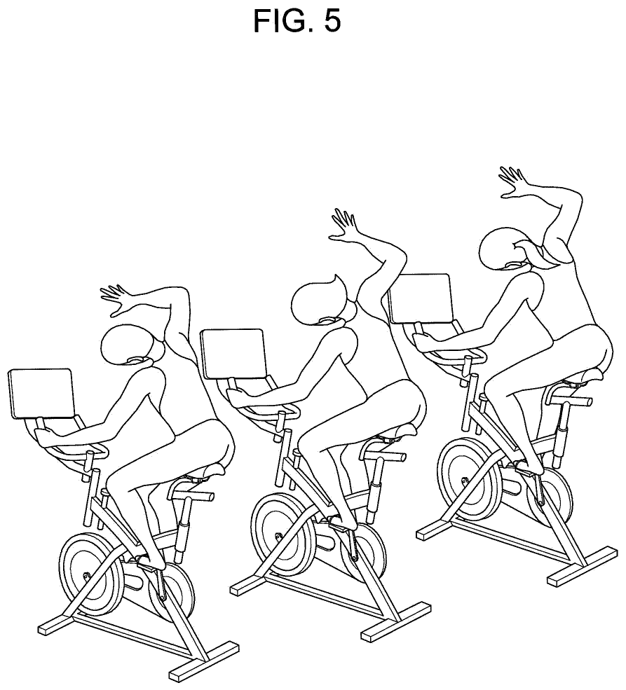

Hereinafter, a motion recognition, and exercise and game mixed rhythmic interior bike system according to an embodiment of the present invention will be described in detail with reference to the accompanying drawings. FIG. 1 is an overall configuration diagram of a motion recognition, and exercise and game mixed rhythmic interior bike system according to an embodiment of the present invention, FIG. 2 is a detailed configuration diagram of a web server in the motion recognition, and exercise and game mixed rhythmic interior bike system according to an embodiment of the present invention, FIG. 3 is a configuration diagram of hardware of the motion recognition, and exercise and game mixed rhythmic interior bike system according to an embodiment of the present invention, FIG. 4 is a diagram illustrating a content output screen of the motion recognition, and exercise and game mixed rhythmic interior bike system according to an embodiment of the present invention, and FIG. 5 is an explanatory diagram of a group game of the motion recognition, and exercise and game mixed rhythmic interior bike system according to an embodiment of the present invention.

As illustrated in FIGS. 1 to 3, the motion recognition, and exercise and game mixed rhythmic interior bike system according to an embodiment of the present invention is configured to include an interior bike 100, a motion recognition sensor 200, a heart rate measurement sensor 250, a controller 300, a web server 400, and a display unit 500.

As illustrated in FIGS. 1 to 3, the interior bike 100 includes a rotational angle detection sensor 110 sensing a pedal rotation angular speed. The interior bike 100 is a general interior bike, and includes a load adjusting means, a handle, a saddle, etc.

The motion recognition sensor 200 is a means for recognizing a head or upper body motion of a player. The motion recognition sensor 200 may be a sensor including an accelerometer, an angular speed meter, or a gyro. Alternatively, the motion recognition sensor 200 may be a depth image camera. Preferably, the motion recognition sensor 200 may be an infrared sensor including a light emitting and light receiving means. The motion recognition sensor 200 is used mainly for tracking a location of the head, but may be used as a means for tracking an exercise motion of an upper body in the case of an image.

The heart rate measurement sensor 250 is a means for measuring a heart rate of the player. The system may include a separate bio signal sensor in addition to the heart rate measurement sensor 250. The heart rate measurement sensor 250 is used for measuring a subjective exercise strength and a bio state of the player.

As illustrated in FIGS. 1 to 3, the controller 300 receives and transfers sensing signals of the rotational angle detection sensor 110, the motion recognition sensor 200, and the heart rate measurement sensor 250 to the web server 400. The controller 300 may be replaced with a separate computer terminal, and may be replaced with a smart phone having a dedicated application so as to transmit and receive the sensor signals.

As illustrated in FIGS. 1 to 3, the web server 400 determines whether performing the task motion given to the player is successful based on the signal of the motion recognition sensor of the controller 300, and generates a content image to which whether the player succeeds in performing the task motion is reflected and transmits the generated content image to the content controller 300.

The display unit 500 displays an image transmitted from the web server 400 through the controller 300. The display unit 500 is preferably a separate display device, but may be replaced with a display device of the smart phone.

In the motion recognition, and exercise and game mixed rhythmic interior bike system according to an embodiment of the present invention, as illustrated in FIGS. 1 to 3, the web server 400 is configured to include a sensor signal reception unit 410, a task content selection unit 420, a task motion success determination unit 430, a pedal rotation task success determination unit 440, a content image reflection unit 450, and an exercise data management unit 460.

The sensor signal reception unit 410 receives sensing signals of the rotational angle detection sensor 110, the motion recognition sensor 200, and the heart rate measurement sensor 250.

The task content selection unit 420 provides a selection menu to select an exercise task to be performed by the player, a difficulty level of the task, or a slow or fast degree of a rhythm motion, and provides the content image selected by the player.

The task motion success determination unit 430 analyzes a motion signal received from the motion recognition sensor 200 to determine whether a head or upper body motion pattern of the player corresponds to a task motion range given by the contents (instructor avatar) (the motion task is successful).

The pedal rotation task success determination unit 440 analyzes an angular speed signal of the pedal received from the rotational angle detection sensor 110 to determine whether a pedal rotation pattern of the player corresponds to a task pedal rotation range given by the contents (instructor avatar) (the pedal rotation task is successful).

The content image reflection unit 450 provides a content image to which whether the player succeeds in the task motion or whether the player succeeds in the pedal rotation task.

The exercise data management unit 460 stores and manages player exercise data including the type of task selected by the player, a player heart rate of the player by the heart rate measurement sensor 250, whether the player succeeds in the task motion or whether the player succeeds in the pedal rotation task.

In the motion recognition, and exercise and game mixed rhythmic interior bike system according to an embodiment of the present invention, as illustrated in FIGS. 1 to 3, 4, and 5, the web server 400 may be configured to further include a community game progress unit 470 which may attack other players online or on the same or different space or defend the player from other players when determining whether the motion of the head of the player achieves the given task motion.

In the motion recognition, and exercise and game mixed rhythmic interior bike system according to an embodiment of the present invention, as illustrated in FIGS. 1 to 3, the motion recognition sensor 200 is an infrared sensor that tracks the head location of the player, and is installed to adjust an angle at a handle unit of the interior bike 100 or a location adjacent to the handle unit.

In the motion recognition, and exercise and game mixed rhythmic interior bike system according to an embodiment of the present invention, as illustrated in FIGS. 1 to 3, the interior bike 100 is preferably configured to further include a haptic feedback means 130 that allows the contents to interface the player at the handle or saddle.

In the motion recognition, and exercise and game mixed rhythmic interior bike system according to an embodiment of the present invention, as illustrated in FIGS. 1 to 3, the motion recognition sensor 200 is a sensor that tracks and senses the head location or the head motion of the player.

In an embodiment of the present invention, the web server 400 may be configured to further include an exercise amount analysis unit 470, and the exercise amount analysis unit 470 calculates an exercise amount of the player by using pedal rotation angular speed information provided by the rotational angle detection sensor 110, load information of the pedal, and head motion information of the player, and provides the calculated exercise amount to the exercise data management unit 460.

In the motion recognition, and exercise and game mixed rhythmic interior bike system according to an embodiment of the present invention, the exercise amount analysis unit 470 estimates a movement of the upper body inversely by using motion direction, speed, and trajectory information of the head, and calculates the exercise amount based on the estimated movement of the upper body and body information (height and weight) of the player, in calculating the exercise amount of the player by using the head movement information of the player.

In the motion recognition, and exercise and game mixed rhythmic interior bike system according to an embodiment of the present invention, 1) the exercise data management unit 460 recommends the exercise task to be performed by the player, the difficulty level of the task, and the slow and fast degree of the rhythm motion based on the existing stored performing task of the player, a success performing degree of the task, and heart rate information data at that time. 2) The exercise data management unit 460 provides a warning message when determining an exercise overload based on the existing stored heart rate information of the player.

Although the present invention has been described in connection with the preferred embodiments mentioned above, the scope of the present invention is not limited to this embodiment, and the scope of the present invention is determined by the following claims and will include various modifications and variations.

The reference numerals described in the following claims are simply to assist understanding of the invention, so that it is apparent that the reference numerals do not affect the analysis of the scope of the rights and the scope of the rights should not be interpreted to be narrow by the described reference numerals.

What is claimed is:

1. A motion recognition, and exercise and game mixed rhythmic interior bike system comprising:
an interior bike (100) including a rotational angle detection sensor (110) sensing a pedal rotation angular speed;
a motion recognition sensor (200) recognizing a head or upper body motion of a player;
a heart rate measurement sensor (250) measuring a heart rate of the player;
a controller (300) receiving and transferring sensing signals of the rotational angle detection sensor (110), the motion recognition sensor (200), and the heart rate measurement sensor (250) to a web server (400);
the web server (400) determining whether performing the task motion given to the player is successful based on the signal of the motion recognition sensor of the controller (300), and generating a content image to which whether the player succeeds in performing the task motion is reflected and transmitting the generated content image to the content controller (300); and
a display unit (500) displaying an image transmitted from the web server (400) through the controller (300).

2. The motion recognition, and exercise and game mixed rhythmic interior bike system of claim 1, wherein the web server 400 includes
a sensor signal reception unit (410) receiving the sensing signals of the rotational angle detection sensor (110), the motion recognition sensor (200), and the heart rate measurement sensor (250),
a task content selection unit (420) providing a selection menu to select an exercise task to be performed by the player, a difficulty level of the task, or a slow or fast degree of a rhythm motion, and provides the content image selected by the player,
a task motion success determination unit (430) analyzes a motion signal received from the motion recognition sensor (200) to determine whether a head or upper body motion pattern of the player corresponds to a task motion range given by the contents (instructor avatar, the motion task is successful),
a pedal rotation task success determination unit (440) analyzes an angular speed signal of the pedal received from the rotational angle detection sensor (110) to determine whether a pedal rotation pattern of the player corresponds to a task pedal rotation range given by the contents (instructor avatar, the pedal rotation task is successful),
a content image reflection unit (450) provides a content image to which whether the player succeeds in the task motion or whether the player succeeds in the pedal rotation task, and
an exercise data management unit (460) stores and manages player exercise data including the type of task selected by the player, a player heart rate of the player by the heart rate measurement sensor (250), whether the player succeeds in the task motion or whether the player succeeds in the pedal rotation task.

3. The motion recognition, and exercise and game mixed rhythmic interior bike system of claim 2, wherein the web server (400) is configured to further include a community game progress unit (470) which may attack other players online or on the same or different space or defend the player from other players when determining whether the motion of the head of the player achieves the given task motion.

4. The motion recognition, and exercise and game mixed rhythmic interior bike system of claim 2, wherein the motion recognition sensor (200) is an infrared sensor that tracks the head location of the player, and is installed to adjust an angle at a handle unit of the interior bike (100) or a location adjacent to the handle unit.

5. The motion recognition, and exercise and game mixed rhythmic interior bike system of claim 2, wherein the interior bike (100) is configured to further include a haptic feedback means (130) that allows the contents to interface the player at the handle or saddle.

6. The motion recognition, and exercise and game mixed rhythmic interior bike system of claim 2, wherein the motion recognition sensor (200) is a sensor that tracks and senses the head location or the head motion of the player, and the web server (400) is configured to further include an exercise amount analysis unit (470), and the exercise amount analysis unit (470) calculates an exercise amount of the player by using pedal rotation angular speed information provided by the rotational angle detection sensor (110), load information of the pedal, and head motion information of the player, and provides the calculated exercise amount to the exercise data management unit (460).

7. The motion recognition, and exercise and game mixed rhythmic interior bike system of claim 6, wherein the exercise amount analysis unit (470) estimates a movement of the upper body inversely by using motion direction, speed, and trajectory information of the head, and calculates the exercise amount based on the estimated movement of the upper body and body information (height and weight) of the player, in calculating the exercise amount of the player by using the head movement information of the player.

8. The motion recognition, and exercise and game mixed rhythmic interior bike system of claim 2, wherein the exercise data management unit (460)
1. recommends the exercise task to be performed by the player, the difficulty level of the task, and the slow and fast degree of the rhythm motion based on the existing stored performing task of the player, a success performing degree of the task, and heart rate information data at that time, and
2. provides a warning message when determining an exercise overload based on the existing stored heart rate information of the player.
